(19) United States
(12) Patent Application Publication
(10) Pub. No.: US 2025/0187822 A1
(43) Pub. Date: Jun. 12, 2025

(54) REFUSE VEHICLE WITH SELF-ADJUSTING CYCLE TIME

(71) Applicant: Oshkosh Corporation, Oshkosh, WI (US)

(72) Inventors: Joe Nelson, Oshkosh, WI (US); Todd Cannon, Oshkosh, WI (US); Andy Cornelius, Oshkosh, WI (US); Zhenyi Wei, Oshkosh, WI (US)

(73) Assignee: Oshkosh Corporation, Oshkosh, WI (US)

(21) Appl. No.: 18/970,081

(22) Filed: Dec. 5, 2024

Related U.S. Application Data
(60) Provisional application No. 63/606,774, filed on Dec. 6, 2023.

(51) Int. Cl. B65F 3/14

(52) U.S. Cl. CPC B65F 3/14; B65F 2003/146

(57) ABSTRACT

A refuse vehicle includes an implement assembly, a sensor, and processing circuitry. The implement assembly performs a cycle operation over a cycle time period. The sensor is configured to obtain sensor data indicative of the cycle time period. The processing circuitry is configured to determine, based on the sensor data, a current value of the cycle time period. The processing circuitry is also configured to determine, based on a comparison between the current value of the cycle time period and a target value of the cycle time period, an adjustment to control of the implement assembly. The adjustment to the control of the implement assembly may be determined such that the current value of the cycle time period is substantially the same as the target value of the cycle time period. The processing circuitry can also be configured to control operation of the implement assembly according to the adjustment.

### CROSS-REFERENCE TO RELATED PATENT APPLICATION

This application claims the benefit of and priority to U.S. Provisional Application No. 63/606,774, filed Dec. 6, 2023, the entire disclosure of which is incorporated by reference herein.

### BACKGROUND

The present disclosure generally relates to the field of refuse vehicles. More specifically, the present disclosure relates to control systems for refuse vehicles.

### SUMMARY

One embodiment of the present disclosure relates to a refuse vehicle. The refuse vehicle includes an implement assembly, a sensor, and processing circuitry. The implement assembly is configured to perform a cycle operation over a cycle time period. The sensor is configured to obtain sensor data indicative of the cycle time period. The processing circuitry is configured to determine, based on the sensor data, a current value of the cycle time period. The processing circuitry is also configured to determine, based on a comparison between the current value of the cycle time period and a target value of the cycle time period, an adjustment to control of the implement assembly. The adjustment to the control of the implement assembly may be determined such that the current value of the cycle time period is substantially the same as the target value of the cycle time period. The processing circuitry can also be configured to control operation of the implement assembly according to the adjustment.

In some embodiments, the implement assembly is a side-loading arm configured to perform the cycle operation including grasping, lifting, emptying, and returning a refuse container to a ground surface. In some embodiments, the adjustment to the control of the side-loading arm includes operating a hydraulic valve to increase hydraulic fluid to hydraulic components of the side-loading arm responsive to the current value of the cycle time period being less than the target value of the cycle time period.

In some embodiments, the implement assembly is a front-loading implement assembly configured to perform the cycle operation including lifting, emptying, and returning a refuse container to a ground surface. In some embodiments, the implement assembly is a compaction system configured to compact refuse within an inner volume of a body of the refuse vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is a block diagram of a self-adjusting cycle time system for any of the refuse vehicles of FIGS. 1-3, according to an exemplary embodiment;

FIG. 7 is a perspective view of a side loading assembly operable by the self-adjusting cycle time system of FIG. 6, according to an exemplary embodiment;

FIG. 8 is a side view of the side loading assembly of FIG. 7;

FIG. 9 is another block diagram of the self-adjusting cycle time system of FIG. 6, according to an exemplary embodiment;

FIG. 10 is a flow diagram of a process for locally adjusting operation of a system of a refuse vehicle to achieve a target cycle time, according to an exemplary embodiment; and

FIG. 11 is a flow diagram of a process for adjusting operation of systems of a fleet of refuse vehicles to achieve a target cycle time, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Refuse Vehicle

### Front-Loading Configuration

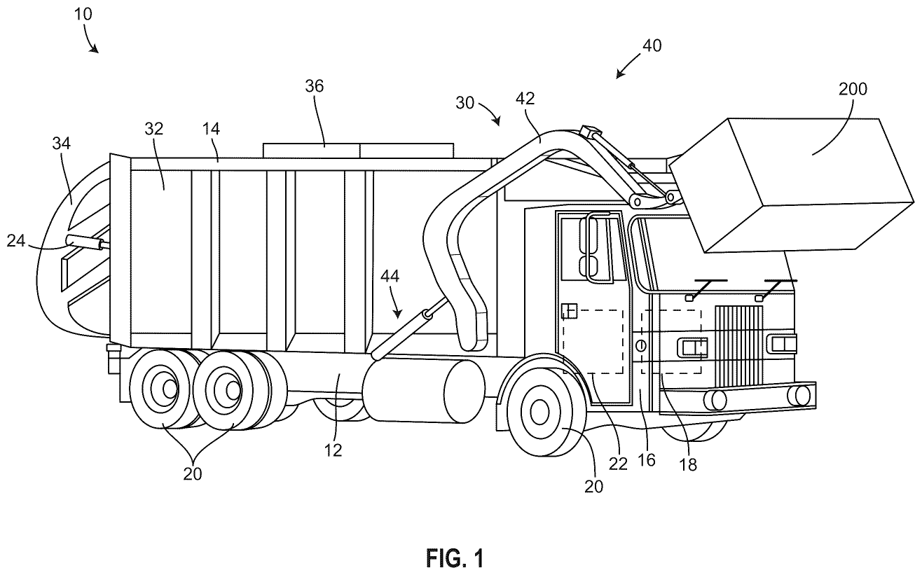

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 (e.g., an inner volume thereof) where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

### Rear-Loading Configuration

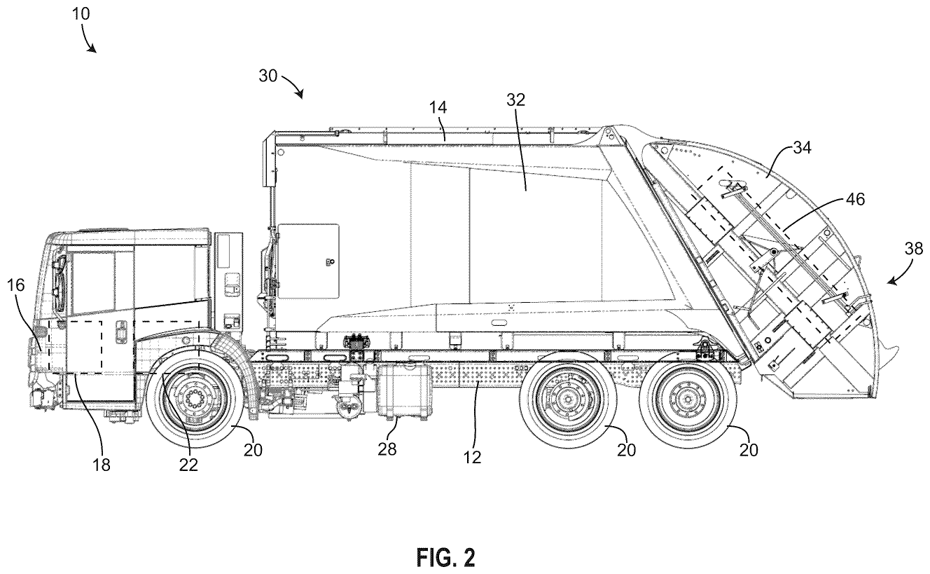

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

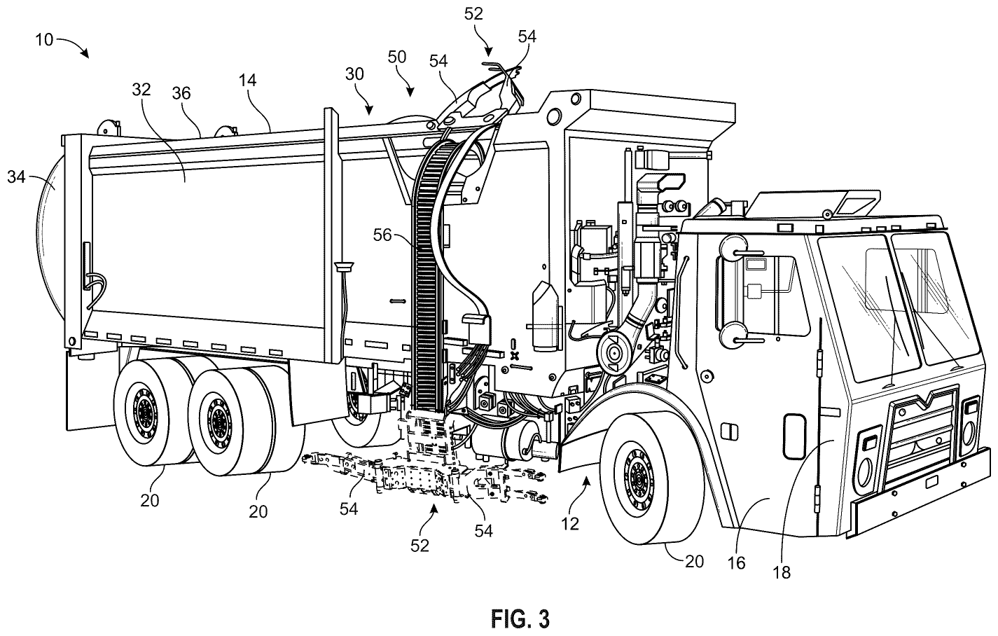

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground (e.g., a ground surface). Once the refuse container has been placed on the ground, the grabber assembly may transition into the disengaged state, releasing the refuse container.

### Control System

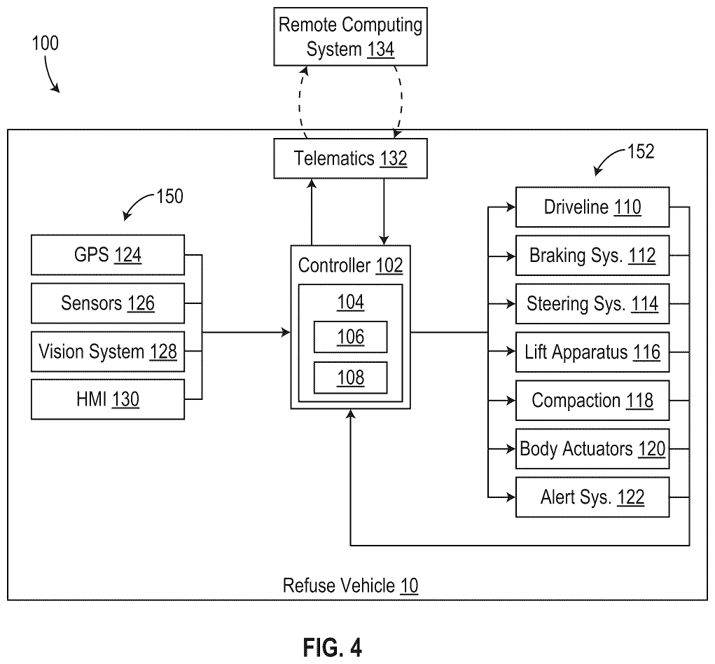

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

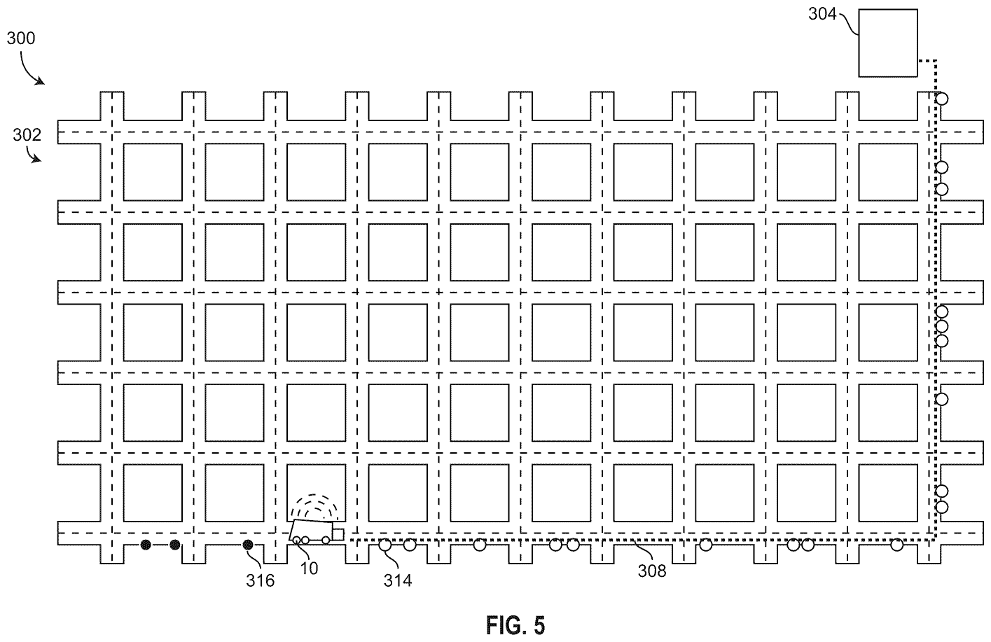

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Self-Adjusting Cycle Time

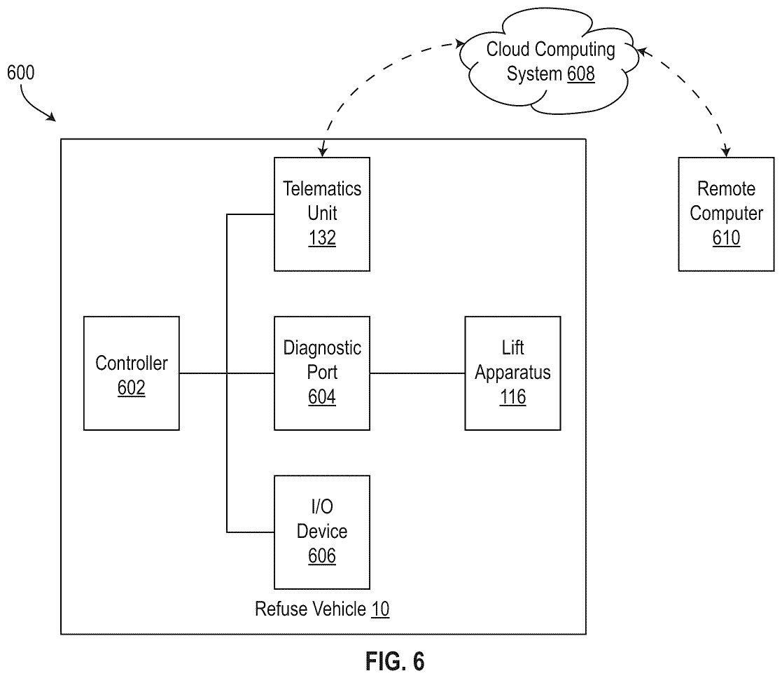

Referring to FIG. 6, the refuse vehicle 10 includes a self-adjusting cycle system 600, according to some embodiments. The self-adjusting cycle system 600 is configured to monitor an amount of time the lift apparatus 116 takes to perform a lifting cycle (e.g., to ascend and descend along a track, to raise, empty, and lower a refuse container, etc.). The self-adjusting cycle system 600 may be implemented by the control system 100 and the controller 102. The self-adjusting cycle system 600 may adjust operation of the lift apparatus 116 such that the lift apparatus 116 performs a lift cycle in a required or desired amount of time. For example, as lift apparatuses 116 deteriorate over time, the time to perform the lifting cycle may also deteriorate. Other factors such as environmental conditions, condition of the refuse vehicle 10, age of the refuse vehicle 10, etc., may also deteriorate the time to perform the lifting cycle. Advantageously, the self-adjusting cycle system 600 operates the lift apparatus 116 in a manner such that factors that deteriorate the time of the lifting cycle are accounted for.

Referring still to FIG. 6, the self-adjusting cycle system 600 includes a controller 602, the telematics unit 132, a diagnostic port 604, an input-output (IO) device 606, the lift apparatus 116, a cloud computing system 608, and a remote computer 610, according to some embodiments. In some embodiments, the self-adjusting cycle system 600 is configured to obtain sensor data from the lift apparatus 116 via the diagnostic port 604 that indicates an amount of time the lift apparatus 116 takes to perform a lifting operation or a lifting cycle. The controller 602 may determine, based on the sensor data, adjustments to controls or operation of the lift apparatus 116 such that the lift apparatus 116 executes the lifting cycle within a required amount of time and consistently performs the lifting cycle within the required amount of time, regardless of degradation state or temperature of hydraulic fluid of the lift apparatus 116. The controller 602 may monitor amount of time to perform the lifting cycle over a time period in order to identify an average amount of time the lift apparatus 116 takes to perform the lifting cycle. The adjustment to the lift apparatus 116 or any other implement assembly can mitigate impact of degradation or environmental conditions on the time period. In some embodiments, the average amount of time the lift apparatus 116 takes to perform the lifting cycle is determined by initiating a calibration mode or process at the controller 602. The calibration mode or process can be initiated via a user input from the IO device 606, an automatic or fleet manager input from the remote computer 610 and transferred to the controller 602 via the telematics unit 132 and the cloud computing system 608, or a command provided to the controller 602 via a diagnostics or calibration device plugged into a control network of the refuse vehicle 10. The IO device 606 may include a display with buttons, a touch screen, a keypad, etc. In some embodiments, the average amount of time to perform the lifting cycle is determined during operation of the lift apparatus 116 without requiring the lift apparatus 116 to transition into an exclusive calibration mode, or by allowing the functionality of the calibration mode to operate in the background.

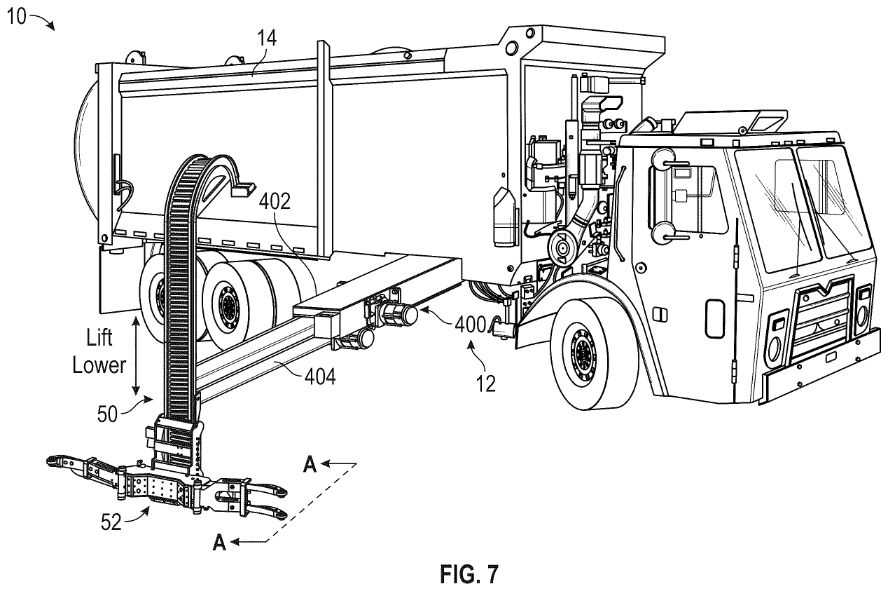

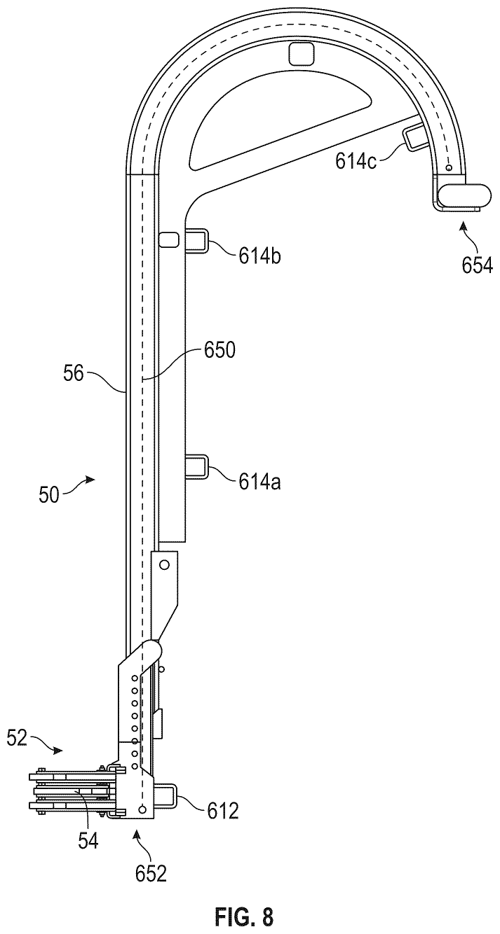

Referring to FIGS. 7 and 8, the refuse vehicle 10 can be, as described above, a side-loading refuse vehicle including the lift assembly 50, the grabber assembly 52, and an extension assembly 400. The extension assembly 400 is coupled with the frame 12 of the vehicle beneath the body 14. The extension assembly 400 includes a first member 402 and a second member 404 that telescopes relative to the first member 402, according to some embodiments. The first member 402 may also telescope relative to the frame 12. The extension assembly 400 is hydraulically driven or electrically driven (e.g., by one or more linear electric actuators, electric motors, etc.), according to some embodiments. In some embodiments, the extension assembly 400 is configured to extend or retract relative to a lateral side of the refuse vehicle 10. The lift assembly 50 and the grabber assembly 52 are positioned on an end of the extension assembly 400 such that extension and retraction of the extension assembly 400 causes the lift assembly 50 and the grabber assembly 52 to be moved laterally outwards from the refuse vehicle 10 in order to grasp a refuse container. The grabber assembly 52 is configured to be driven to grasp the refuse container, ascend the track 56, empty the contents of the refuse container when at the top of the track 56, and then descend the track 56.

During use of the refuse vehicle 10 along a collection route, the refuse vehicle 10 first pulls along side a refuse container. The extension assembly 400 is then operated to extend such that the refuse container is positioned within grabber fingers or arms of the grabber assembly 52. The grabber assembly 52 is then operated to grasp the refuse container. The extension assembly 400 is driven to retract to bring the refuse container towards the refuse vehicle 10. The lift assembly 50 is then operated such that the grabber assembly 52 ascends the track 56 while holding the refuse container. Once the grabber assembly 52 reaches the top of the track 56, the refuse container is tipped, due to the curved shape of the track 56, such that the contents of the refuse container are emptied into the hopper volume of the refuse container. The steps are then performed in reverse in order to place the refuse container to its location on the ground.

The lifting cycle for the side-loading refuse vehicle 10 is measured as an amount of time for the grabber assembly 52 to ascend and descend the track 56, according to some embodiments. In some embodiments, the lifting cycle includes an amount of time for the extension assembly 400 to extend and retract both before and after the grabber assembly 52 is driven to ascend and descend along the track 56.

Referring particularly to FIG. 8, the lift apparatus 50 includes one or more sensors 614 (e.g., proximity sensors) disposed along the track 56. The grabber assembly 52 includes a proximity flag 612 that is configured to interact with the sensors 614 when the grabber assembly 52 translates along the track 56. The proximity flag 612 and the sensors 614 produce signals that are transferred to the controller 602 as the grabber assembly 52 translates past the sensors 614. The controller 602 can use a time at which the signals are produced by the sensors 614 and the proximity flag 612 are obtained in order to identify a speed or rate of transport of the grabber assembly 52 along the track 56.

As shown in FIG. 8, the track 56 defines a path 650 along which the grabber assembly 52 is driven to ascend and descend. The path 650 includes a first end 652 and a second end 654. The first end 652 is a bottom of the track 56. The second end 654 is an upper end of the track 56. The grabber assembly 52 may ascend from the first end 652 of the path 650 to the second end 654 along the path 650 in order to lift the refuse container and dump the refuse container into the hopper of the refuse vehicle 10. Once the contents of the refuse container are dumped into the hopper of the refuse vehicle 10 at the second end 654 of the path 650, the grabber assembly 52 descends the track 56 from the second end 654 to the first end 652. In some embodiments, the lifting cycle time is an amount of time for the grabber assembly 52 to start at the first end 652 of the path 650, ascend the track 56 along the path 650 to the second end 654, empty the contents of the refuse container at the second end 654, and descend the track 56 along the path 650 to the first end 652. The signals or sensor data obtained by the controller 602 from the sensors 614 and the proximity flag 612 can be used by the controller 602 in order to determine the lifting cycle time.

As shown in FIG. 8, the sensors 614 include a first sensor 614a, a second sensor 614b, and a third sensor 614c. The sensors 614 may also include a sensor positioned at the first end 652 of the path 650. The sensors 614 are generally disposed at intervals along the track 56 such that the rate of travel of the grabber assembly 52 along the track 56 can be measured by the controller 602. The sensors 614 can be used in order to identify a location of the grabber assembly 52 along the track during normal operation of the lift assembly 50, and can also be used to determine an amount of time to perform the lifting cycle.

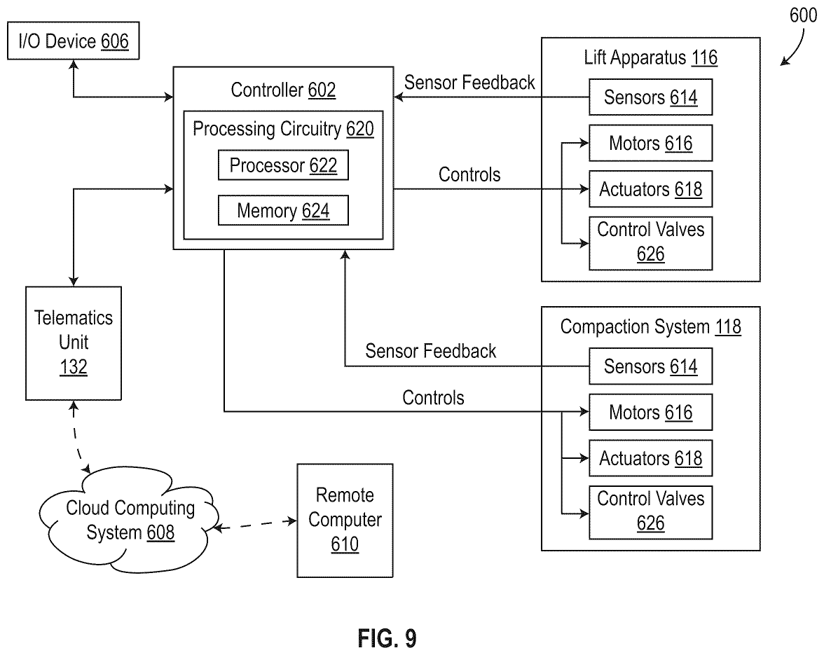

Referring to FIG. 9, the self-adjusting cycle system 600 is shown according to some embodiments. The controller 602 includes processing circuitry 620 including a processor 622 and memory 624. Processing circuitry 620 can be communicably connected with a communications interface of controller 602 such that processing circuitry 620 and the various components thereof can send and receive data via the communications interface. Processor 622 can be implemented as a general purpose processor, an application specific integrated circuit (ASIC), one or more field programmable gate arrays (FPGAs), a group of processing components, or other suitable electronic processing components.

Memory 624 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 624 can be or include volatile memory or non-volatile memory. Memory 624 can include database components, object code components, script components, or any other type of information structure for supporting the various activities and information structures described in the present application. According to some embodiments, memory 624 is communicably connected to processor 622 via processing circuitry 620 and includes computer code for executing (e.g., by at least one of processing circuitry 620 or processor 622) one or more processes described herein.

The controller 602 is configured to receive sensor feedback from the sensors 614 of the lift apparatus 116 (e.g., the sensors 614 of the lift assembly 50 if the refuse vehicle 10 is a side-loading refuse vehicle0. The controller 602 is configured to collect samples of data over time from the sensors 614 in order to identify an average amount of time that the lift apparatus 116 takes to perform the lifting cycle. The sensors 614 may be the proximity sensors as described in greater detail above with reference to FIG. 8, or may include inclinometers that are positioned on the lift assembly 40 (e.g., if the refuse vehicle 10 is a front-loading refuse vehicle). Accordingly, it should be understood that the techniques of the controller 602 as described herein may be implemented for any configuration or any cycle operation (e.g., a cyclical operation) of a refuse vehicle including but not limited to lifting cycles of a side loading refuse vehicle or front loading refuse vehicle. In the case of a front-loading refuse vehicle, the lift assembly 40 can include inclinometers that indicate a current angular position of the lift assembly 40 (e.g., at a first position of a lifting cycle and at a second position of a lifting cycle) such that the amount of elapsed time between times at which the inclinometer measures specific angles that indicate the ends of a lifting cycle are achieved. The sensors 614 can also include position sensors or feedback from actuators (e.g., the lift arm actuators 44) that indicate a position or state of a lifting cycling at which the lift apparatus 116 is currently at.

In this way, the sensor feedback provided by the sensors 614 can be a variety of types of data that indicate a state of the lift apparatus 116 along a lifting cycle. The controller 602 may measure times at which specific values of the sensor feedback are obtained (e.g., a time at which the degree of extension of the lift arm actuators 44 are a specific value, a time at which the inclinometer provides a specific value, a time at which a signal is produced due to the grabber assembly 52 being at one of the sensors 614a-614c, etc.). The controller 602 compares the times at which different values of the sensor feedback is obtained in order to identify an amount of time to perform the lifting cycle. For example, in a front loading refuse vehicle, the controller 602 may measure a first time t₁ at which the inclinometer measures a value indicating that the lift assembly 40 is at a lower position of the lifting cycle, a second time t₂ at which the inclinometer measures a value indicating that the lift assembly 40 is at an upper position of the lifting cycle, and a third time t₃ at which the inclinometer again measures the value indicating that the lift assembly 40 is at the lower position. The controller 602 can determine an amount of time to raise the refuse container (e.g., Δtᵣₐᵢₛₑ=t₂−t₁), an amount of time to lower the refuse container (e.g., Δt_{lower}=t₃−t₂), and an amount of time for the lifting cycle (e.g., Δt_{lift}=t₃−t₁). The controller 602 may obtain multiple values of the amount of time for the lifting cycle (e.g., multiple values of Δt_{lift}) and average the values in order to determine an average amount of time for the lifting cycle (e.g., Δt_{lift,avg}). The controller 602 is similarly configured to determine an amount of time to perform the lifting cycle for side-loading implementations of the refuse vehicle 10. It should be understood that the controller 602 can be configured to use sensor data from any of, or any combination of inclinometers, proximity sensors, position sensors, etc., of lifting apparatuses of side loading refuse vehicles, front loading refuse vehicles, etc., in order to determine the average amount of time to perform the lifting cycle Δt_{lift,avg}.

The controller 602 can also be configured to obtain sensor data from sensors 614 of the compaction system 118 of the refuse vehicle 10, or any other system or apparatus of the refuse vehicle 10 that implements cyclical operation of a task (e.g., tailgate lifting, dumping operations, compaction operations, lifting operations, etc.). In some embodiments, the controller 602 is configured to determine, using similar techniques, an average amount of time to perform any cyclical operation for the refuse vehicle 10 (e.g., an average amount of time to perform a compaction cycle, an average amount of time to perform a read-end lifting cycle, an average amount of time to perform a tailgate lifting cycle, etc.).

Once the controller 602 determines the average amount of time to perform the cyclical operation (e.g., the average amount of time to perform the lifting cycle with the lift apparatus 116 or the average amount of time to perform the compaction cycle with the compaction system 118), the controller 602 is configured to determine adjustments to controllable elements of the system (e.g., the lift apparatus 116 or the compaction system 118) in order to achieve cyclical operation in a desired or target amount of time. For example, if the average amount of time to perform the lifting cycle Δt_{lift,avg} exceeds a target amount of time to perform the lifting cycle, Δt_{target}, the controller 602 can determined adjustments to one or more controllable elements (e.g., motors 616, actuators 618, control valves 626, etc.) in order to perform the lifting cycle in the target amount of time (e.g., controls or control adjustments such that Δt_{lift,avg}˜Δt_{target}). The controls or adjustments to the controls may vary based on the type of drive systems of the lift apparatus 116, the compaction system 118, or any other cyclical operation system of the refuse vehicle 10. For example, if the lift apparatus 116 is a hydraulically driven system and the lift apparatus 116 is lagging in speed of operation (e.g., Δt_{lift,avg}>Δt_{target}), the controller 602 may determine that the lift apparatus 116 should be operated at a faster speed by increasing the output of a hydraulic control valve 626. Likewise, if the lift apparatus 116 is operating too quickly (e.g., Δt_{lift,avg}<Δt_{target}), the controller 602 determines that the lift apparatus 116 should be operated at a slower speed by decreasing output of the hydraulic control valve 626. In some embodiments, the amount or degree to which the control or operation of the lift apparatus 116 or the compaction system 118 is adjusted is determined by the controller 602 based on a difference or comparison between the average cycle time (e.g., Δt_{lift,avg}) and the target cycle time (e.g., Δt_{target}). Specifically, systems that are operating considerably slower than the target cycle time may require more drastic adjustments than system that are only operating slightly slower than the target cycle time. In some embodiments, the control adjustment are incorporated in the controls provided by the controller 602 to the motors 616, the actuators 618, or the control valves 626. It should be understood that the lift apparatus 116 or the compaction system 118 may also be electrical systems and the controller 602 may adjust the speed of operation of the lift apparatus 116 or the compaction system 118 by adjusting a voltage, current, or power supplied to the motors 616 or the actuators 618.

The controller 602 is configured to use any of a predictive algorithm, a model of the system of the refuse vehicle 10, a neural network, a machine learning technique, an artificial intelligence, closed loop control schemes, etc., in order to determine adjustments to operation of the lift apparatus 116 or the compaction system 118 (or any other cyclically operating system of the refuse vehicle 10) in order to match the average cycle time with the target cycle time. In some embodiments, the cloud computing system 608 is configured to implement any of the techniques of the controller 602 as described herein in order to determine adjustments to the lift apparatus 116, the compaction system 118, or any other system of the refuse vehicle 10. The cloud computing system 608 may obtain data from multiple refuse vehicles of a fleet of refuse vehicles 10. In some embodiments, the cloud computing system 608 coordinates adjustments to all of the refuse vehicles 10 of the fleet such that the systems of the refuse vehicles 10 operate according to a same or target cycle time. In some embodiments, the remote computer 610 (e.g., a system administrator) provides display of any of the average cycle times or sensor data in order to notify a fleet manager regarding refuse vehicles 10 that have particularly slow or fast systems. In some embodiments, the controller 602 and the cloud computing system 608 are also configured to obtain operational parameters and environmental conditions along with the sensor feedback. The operational parameters may be currently implemented operational parameters or control settings of the motors 616, the actuators 618, or the control valves 626 of the lift apparatus 116, the compaction system 118, or any other system of the refuse vehicle 10. The environmental conditions can include temperature, humidity, sunlight intensity, etc., at the refuse vehicle 10 as measured by sensors of the refuse vehicle 10. The cloud computing system 608 may record the information obtained from the controllers 602 of the refuse vehicles 10 in the fleet and build a neural network or perform a regression to identify appropriate control settings or adjustments in order to achieve the target cycle time. In some embodiments, the cloud computing system 608 is configured to use the neural network or the regression to provide adjustments for the lift apparatus 116, the compaction system 118, or any other cyclical system of the refuse vehicle 10. The cloud computing system 608 is configured to provide the adjustments or the control settings to the refuse vehicles 10 for use in controlling the lift apparatus 116, the compaction system 118, or the other cyclical systems in order to achieve the target cycle times.

Advantageously, all of the refuse vehicles 10 in a fleet of refuse vehicles may use the same target cycle times for their systems. The self-adjusting cycle system 600 can be implemented across all the refuse vehicles 10 in a fleet so that all of the cyclical operating systems (e.g., the lift apparatuses) of the refuse vehicles 10 operate at the same speed. In this way, all of the side-loading refuse vehicles 10 of a fleet of refuse vehicles may all have a lift cycle that takes a same amount of time, regardless of hydraulic temperature of the individual systems, differing ages or environmental conditions, etc. The self-adjusting cycle system 600 facilitates uniformity with regards to amount of time to perform a routine cyclical operation (e.g., side-loading lift operations, front-loading lift operations, etc.). For example, an operator that uses one refuse vehicle 10 a first day or at a first time and later uses a different refuse vehicle 10 has an improved experience since the amount of time to operate the lift apparatus 116 and the compaction apparatus 118 is substantially the same. Additionally, the time to perform the cyclical operations (e.g., the loading of the refuse containers) does not vary throughout the day due to changing hydraulic temperatures, changed amount of hydraulic fluid after servicing, different ambient or environmental conditions, etc.

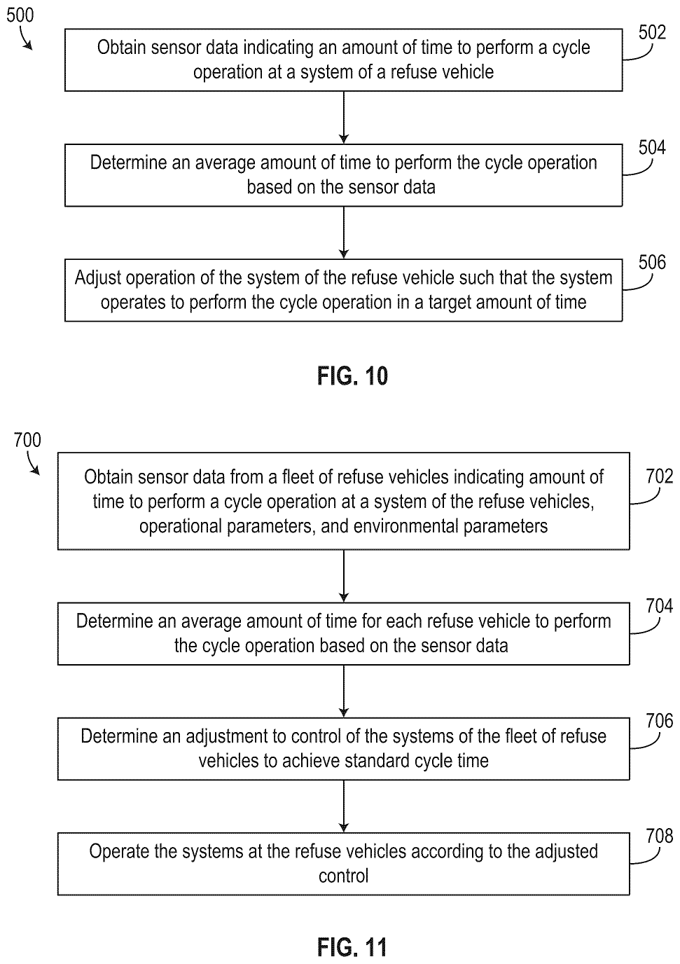

Referring to FIG. 10, a flow diagram of a process 500 for adjusting operation of a cyclical system of a refuse vehicle includes steps 502-506, according to some embodiments. The process 500 can be performed by the self-adjusting cycle system 600, the controller 602 thereof, or the controller 102. The process 500 advantageously is implemented across a fleet of refuse vehicles using a same target time for the vehicles such that all of the vehicles in the fleet operate their cyclical systems (e.g., lift systems, compaction systems, loading systems, etc.) at substantially a same time duration.

The process 500 includes obtaining sensor data indicating an amount of time to perform a cycle operation (e.g., a cyclical operation, a recurring operation, a periodic operation, etc.) at a system of a refuse vehicle (step 502), according to some embodiments. In some embodiments, step 502 is performed by the controller 602. The system may be a lifting system, a loading system, a tailgate system, a compaction system, or any other system of a refuse vehicle that routinely operates in a cyclical manner or at regular intervals. For example, the system may be a side-loading arm or implement (e.g., the lift assembly 50, the grabber assembly 52, and the extension assembly 400) of a refuse vehicle that operates in order to grasp, raise, empty, lower, and release a refuse container at a lateral side of the refuse vehicle. Similarly, the system may be a front-end loading system of a front-end loading refuse vehicle such as lift assembly 40. The sensor data is obtained from one or more proximity sensors, encoders, inclinometers, orientation sensors, etc., in order to identity a time at which the system begins its cyclical operation and a time at which the system ends its cyclical operation, according to some embodiments. The sensor data indicates an elapsed amount of time for the system to perform the cycle operation (e.g., the lifting operation).

The process 500 includes determining an average amount of time to perform the cycle operation based on the sensor data (step 504), according to some embodiments. In some embodiments, step 502 is performed over a time period where multiple cycles are performed by the system. The step 504 includes using the data obtained in step 502 in order to determine an average or mean value of the amount of time that the system is currently taking to perform the cycle operation. The average amount of time is specific to the refuse vehicle at which the process 500 is being performed. Step 504 can be performed by the controller 602.

The process 500 includes adjusting operation of the system of the refuse vehicle such that the system operates to perform the cycle operation in a target amount of time (step 506), according to some embodiments. In some embodiments, step 506 is performed by the controller 602 by adjusting operation of one or more controllable elements or control parameters of the system. For example, step 506 can include operating an energy storage system in order to discharge additional power to an electric motor or actuator of the system that powers the system if the average amount of time to perform the cycle operation is less than the target amount of time (e.g., the system is operating slowly). Likewise, step 506 can include increasing or opening a hydraulic valve or increasing the rate at which a hydraulic motor operates in order to increase the speed of the system and decrease the average amount of time to perform the cycle operation to match the target amount of time. The adjustment to the operation of the system is determined by the controller 602 in step 506 based on a degree or amount by which the average amount of time to perform the cycle operation deviates from the target amount of time, and in which direction. For example, a system that is operating far below the target amount of time (e.g., very slowly) may require a more drastic adjustment than a system that is operating only slightly below the target amount of time. The controller 602 can use different relationships, a neural network, machine learning, a predictive model of the system, etc., in order to determine a degree and direction of the adjustment of the operation of the system.

Referring to FIG. 11, a flow diagram of a process 700 for adjusting operation of a system of a refuse vehicle across a fleet of refuse vehicles includes steps 702-708, according to some embodiments. In some embodiments, the process 700 is performed by the self-adjusting cycle system 600, or by the cloud computing system 608 that communicates with the self-adjusting cycle systems 600 of each refuse vehicle in a fleet of refuse vehicles. In some embodiments, the process 700 is performed such that an amount of time it takes a system of the refuse vehicles to perform a cycle operation (e.g., a lifting cycle) is consistent across the fleet. Advantageously, the process 700 facilitates uniformity across the fleet of refuse vehicles regardless of current state, age, environmental conditions, hydraulic fluid temperature, hydraulic fluid quantity, etc., of the systems of the refuse vehicles.

The process 700 includes obtaining sensor data from a fleet of refuse vehicles indicating amount of time to perform a cycle operation at a system of the refuse vehicles, operational parameters, and environmental parameters (step 702), according to some embodiments. In some embodiments, step 702 is performed by the cloud computing system 608 or the controller 602 of the self-adjusting cycle system 600. In some embodiments, step 702 includes obtaining sensor data from the fleet of refuse vehicles in order to determine an average amount of time it takes a similar system for each of the refuse vehicles to perform the cycle operation. The sensor data can be the same as or similar to the sensor data obtained in step 502 of the process 500. In some embodiments, the operational parameters include control parameters that are currently used by the system in order to perform the cycle position. For example, the operational parameters can include amount of power drawn by a motor or actuator of the system, speed or an operating characteristic of a hydraulic motor, position of a hydraulic valve, etc. The environmental parameters can include age of the refuse vehicle, ambient conditions at the refuse vehicle such as temperature, sunlight intensity, moisture, etc.

The process 700 includes determining an average amount of time for each refuse vehicle to perform the cycle operation based on the sensor data (step 704), according to some embodiments. In some embodiments, step 704 is performed by the controller 602 or the cloud computing system 608. The average amount of time may be determined for each of the refuse vehicles such that the refuse vehicles can be compared to each other to identify refuse vehicles that have a system that deviates from the rest of the refuse vehicles (e.g., a refuse vehicle that has a particularly slow or fast system).

The process 700 includes determining an adjustment to control of the systems of the fleet of refuse vehicles to achieve standard cycle time (step 706), according to some embodiments. In some embodiments, step 706 is performed by the cloud computing system 608. The cloud computing system 608 is configured to use any of a machine learning technique, an artificial intelligence technique, a regression, a model, etc., in order to determine the adjustments to the control of the systems of each refuse vehicle. The cloud computing system 608 may use historical data obtained from the fleet of refuse vehicles in order to make an informed decision to adjustments to the systems in order to achieve a standardized or target cycle time. In some embodiments, the cloud computing system 608 determines adjustments for hydraulic valves, electric motors, electric actuators, etc., of the systems. The cloud computing system 608 may communicate vehicle-specific control adjustments to each of the refuse vehicles in the fleet so that the cyclical systems of the refuse vehicles all operate at the same pace.

The process 700 includes operating the systems at the refuse vehicles according to the adjusted control (step 708), according to some embodiments. In some embodiments, step 708 is performed locally at the controller 602 of the refuse vehicles 10 using the adjustment determined in step 706 at the cloud computing system 608. Step 708 can be performed at each of the refuse vehicles so that the cycle time of the systems is substantially uniform and matches a target time across the entire fleet.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle, comprising:
an implement assembly configured to perform a cycle operation over a cycle time period;
a sensor configured to obtain sensor data indicative of the cycle time period; and
processing circuitry, configured to:
determine, based on the sensor data, a current value of the cycle time period;
determine, based on a comparison between the current value of the cycle time period and a target value of the cycle time period, an adjustment to control of the implement assembly such that the current value of the cycle time period is substantially the same as the target value of the cycle time period; and
control operation of the implement assembly according to the adjustment.

2. The refuse vehicle of claim 1, wherein the implement assembly is a side-loading arm configured to perform the cycle operation including grasping, lifting, emptying, and returning a refuse container to a ground surface.

3. The refuse vehicle of claim 2, wherein the adjustment to the control of the side-loading arm comprises operating a hydraulic valve to increase hydraulic fluid to hydraulic components of the side-loading arm responsive to the current value of the cycle time period being less than the target value of the cycle time period.

4. The refuse vehicle of claim 1, wherein the adjustment to the control of the implement assembly comprises operating a hydraulic valve to increase hydraulic fluid to hydraulic components of the implement assembly responsive to the current value of the cycle time period being less than the target value of the cycle time period, or operating the hydraulic valve to decrease hydraulic fluid to hydraulic components of the implement assembly responsive to the current value of the cycle time period being greater than the target value of the cycle time period.

5. The refuse vehicle of claim 1, wherein the implement assembly is a front-loading implement assembly configured to perform the cycle operation including lifting, emptying, and returning a refuse container to a ground surface.

6. The refuse vehicle of claim 1, wherein the implement assembly comprises a compaction system configured to compact refuse within an inner volume of a body of the refuse vehicle.

7. The refuse vehicle of claim 1, wherein determining the adjustment to the control of the implement assembly mitigates an impact of degradation or environmental conditions on the cycle time period.

8. The refuse vehicle of claim 1, wherein the sensor is a first of a plurality of proximity sensors configured to detect motion of the implement assembly past the plurality of proximity sensors.

9. The refuse vehicle of claim 1, wherein the sensor comprises an inclinometer, the processing circuitry configured to determine, based on a plurality of times at which values of the sensor data are obtained from the inclinometer, the current value of the cycle time period.

10. The refuse vehicle of claim 1, wherein the current value of the cycle time period is an average value of the cycle time period, the processing circuitry configured to determine the average value of the cycle time period based on a plurality of values of the cycle time period determined based on the sensor data obtained over a plurality of performances of the cycle operation.

11. The refuse vehicle of claim 1, wherein the adjustment to the control of the implement assembly comprises an adjustment to a voltage, current, or power supplied to an electrical motor or actuator of the implement assembly.

12. The refuse vehicle of claim 1, wherein the processing circuitry is configured to determine the adjustment to the control of the implement assembly such that the current value of the cycle time period is driven toward the target value of the cycle time period using a machine learning technique or a closed loop control scheme.

13. The refuse vehicle of claim 12, wherein the processing circuitry is configured to use environmental conditions to determine the adjustment to the control of the implement assembly.

14. The refuse vehicle of claim 13, wherein the environmental conditions comprise at least one of temperature, humidity, or sunlight intensity at the refuse vehicle.

15. The refuse vehicle of claim 1, wherein the processing circuitry is locally positioned on the refuse vehicle.

16. A system, comprising:
a plurality of refuse vehicles, each of the plurality of refuse vehicles comprising (i) an implement assembly configured to perform a cycle operation over a cycle time period, and (ii) a sensor configured to obtain sensor data indicative of the cycle time period; and
processing circuitry configured to:
determine, based on the sensor data, a plurality of current values of the cycle time period for the plurality of refuse vehicles;
determine, based on a comparison between each of the plurality of current values of the cycle time period and a target value of the cycle time period, a plurality of adjustments to control of the implement assembly of each the plurality of refuse vehicles such that the current value of the cycle time period of each of the plurality of refuse vehicles is substantially the same as the target value of the cycle time period; and
initiate operation of the implement assemblies of the plurality of refuse vehicles according to the adjustments such that the cycle time periods of the implement assembly of the plurality of refuse vehicles are substantially the same.

17. The system of claim 16, wherein the processing circuitry is configured to transmit, to telematics units of the plurality of refuse vehicles, the adjustment to the control of the implement assembly of the plurality of refuse vehicles.

18. The system of claim 16, wherein the processing circuitry is a cloud computing system that is configured to communicate with the plurality of refuse vehicles such that the implement assemblies of the plurality of refuse vehicles operate at the target value of the cycle time period.

19. A method of adjusting operation of an implement of a refuse vehicle, the method comprising:
obtaining sensor data indicating an amount of time that the implement takes to perform a cycle operation;
determining, based on a comparison between the amount of time that the implement takes to perform the cycle operation and a target amount of time, an adjustment to a control of the implement such that the amount of time that the implement takes to perform the cycle operation is the target amount of time; and
operating the implement according to the adjustment such that the implement takes the target amount of time to perform the cycle operation.

20. The method of claim 19, wherein determining the adjustment to the control of the implement comprises increasing a speed at which the implement performs the cycle operation in response to the amount of time that the implement takes to perform the cycle operation being less than the target amount of time, and decreasing the speed at which the implement performs the cycle operation in response to the amount of time that the implement takes to perform the cycle operation being greater than the target amount of time.
